(19) United States
(12) Patent Application Publication
(10) Pub. No.: US 2015/0020013 A1
(43) Pub. Date: Jan. 15, 2015

(54) REMOTE OPERATION OF APPLICATIONS USING RECEIVED DATA

(71) Applicant: Samsung Electronics Co., Ltd., Gyeonggi-do (KR)

(72) Inventors: Junghun KIM, Gyeonggi-do (KR); Seokhee NA, Incheon (KR); Joohark PARK, Gyeonggi-do (KR); Seungpyo HONG, Seoul (KR)

(21) Appl. No.: 14/319,539

(22) Filed: Jun. 30, 2014

(30) Foreign Application Priority Data
Jul. 12, 2013 (KR) 10-2013-0082204

(51) Int. Cl. G06F 3/14; G06F 3/0486

(52) U.S. Cl. CPC G06F 3/14; G06F 3/0486
USPC 715/769; 710/7

(57) ABSTRACT

An electronic device is provided including: a connection unit to connect to an external device; and a processor configured to: receive data and associated attribute information from an external device connected to the electronic device; and process the data by executing an application related to the attribute information.

### CLAIM OF PRIORITY

This application claims the benefit under 35 U.S.C. §119(a) of a Korean patent application filed on Jul. 12, 2013 in the Korean Intellectual Property Office and assigned Serial No. 10-2013-0082204, the entire disclosure of which is hereby incorporated by reference.

### TECHNICAL FIELD

The present disclosure relates to electronic device, and more particularly, to remotely operating applications using received data.

### BACKGROUND

Due to recent advances in hardware technologies and, electronic devices can perform user functions in combination with other devices. Performing user functions in combination with other devices could increase the functionality of the electronic devices and result in a richer user experience.

### SUMMARY

When electronic devices are connected, one electronic device may operate applications installed in the other electronic device. When an application being executed on a first electronic device is invoked by a second electronic device, data associated with the application may be sent from the first electronic device to the second electronic device. Then, the second electronic device may display the data associated with the application.

An image displayed on a first electronic device (e.g. smartphone) may be sent to a second electronic device (e.g. TV or desktop computer) and displayed on the second electronic device. Thereafter, in response to a user input using the image (e.g. drag and drop), the second electronic device may send data to the first electronic device. However, in such a transmission scheme, data is merely sent to a preset folder without consideration of user experience (UX) in the first electronic device and second electronic device.

According to one aspect of the disclosure, a method for operating an electronic device is provided, the method comprising: receiving data and associated attribute information from an external device connected to the electronic device; and processing the data by executing an application related to the attribute information.

According to another aspect of the disclosure, an electronic device is provided comprising: a connection unit to connect to an external device; and a processor configured to: receive data and associated attribute information from an external device connected to the electronic device; and process the data by executing an application related to the attribute information.

### BRIEF DESCRIPTION OF THE DRAWINGS

FIG. 1 illustrates an overview of an app operation system according aspects of the present disclosure;

FIG. 2 is a block diagram of an example of a first electronic device 100 according to aspects of the present disclosure;

FIG. 3 is a block diagram of an example of the second electronic device 200 according to aspects of the present disclosure;

FIG. 4 is a sequence diagram of an example of a process for sending data according to aspects of the present disclosure;

FIG. 5 is a schematic diagram depicting an example of the process discussed with respect to FIG. 4 according to aspects of the present disclosure;

FIG. 6 is a sequence diagram of an example of a process for playing data according to aspects of the present disclosure;

FIG. 7 is a schematic diagram depicting an example of the process discussed with respect to FIG. 6 according to aspects of the present disclosure;

FIG. 8 is a sequence diagram depicting an example of a process for storing data according to aspects of the present disclosure;

FIG. 9 is a schematic diagram depicting an example of the process discussed with respect to FIG. 8 according to aspects of the present disclosure;

FIG. 10 is a sequence diagram depicting an example of a process for transmitting data;

FIG. 11 is a schematic diagram of the process discussed with respect to FIG. 10 according to aspects of the present disclosure;

FIG. 12 is a sequence diagram depicting another example of a process for transmitting data according to aspects of the present disclosure;

FIG. 13 is a schematic diagram depicting an example of the process discussed with respect to FIG. 12 according to aspects of the present disclosure;

FIG. 14 is a sequence diagram depicting yet another example of a process for transmitting data according to aspects of the present disclosure;

FIG. 15 is a sequence diagram depicting yet another example of a process for transmitting data according to aspects of the present disclosure; and

FIGS. 16A, 16B and 16C are schematic diagrams depicting example(s) of the process discussed with respect to FIG. 15 according to aspects of the present disclosure.

### DETAILED DESCRIPTION

Hereinafter, aspects of the present disclosure are described in detail with reference to the accompanying drawings.

Detailed descriptions of well-known functions and structures incorporated herein may be omitted to avoid obscuring the subject matter of the present disclosure. Detailed descriptions of components having substantially the same configurations and functions may also be omitted.

In the drawings, some elements are exaggerated, omitted or only outlined in brief, and thus may be not drawn to scale. The present disclosure is not limited by relative sizes of objects and intervals between objects in the drawings.

In the following description, the electronic device may be a smartphone, tablet computer, laptop computer, digital camera, smart TV, personal digital assistant (PDA), electronic note, desktop computer, portable multimedia player (PMP), media player (such as an MP3 player), audio system, smart wrist watch, game console, and home appliance with a touchscreen (such as a refrigerator, TV, or washing machine). In the description, electronic devices of different types may be utilized. For example, a first electronic device may be a smartphone, and a second electronic device may be a smart TV. Electronic devices of the same type may also be utilized. Electronic devices may be of the same type but may differ in performance. For example, the first electronic device and second electronic device may be smartphones, but the first electronic device may have a larger screen size than the second electronic device. The first electronic device may also have a faster CPU compared with the second electronic device. Electronic devices may include different components. For example, the first electronic device may include a mobile communication module and the second electronic device lack a mobile communication module. In addition, electronic devices may differ in terms of platform (e.g. firmware and operating system).

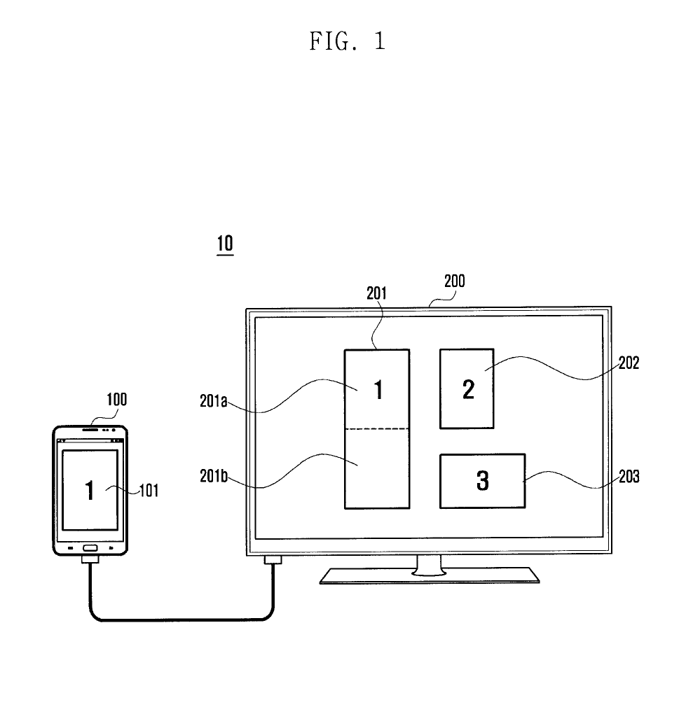

FIG. 1 illustrates an example of an app operation system according to aspects of the present disclosure.

Referring to FIG. 1, the app operation system 10 may include a first electronic device 100 and a second electronic device 200. For example, one of the first electronic device 100 and the second electronic device 200 may be used as an app operation device and the other thereof may be used as an app output device. In the following description, it is assumed that the first electronic device 100 is used as an app operation device and the second electronic device 200 is used as an app output device.

The app operation system 10 may output data related to an application executed on the first electronic device 100 through the second electronic device 200. For example, when three apps are executed on the first electronic device 100, data of at least one executed app may be output through the second electronic device 200. The first electronic device 100 may maintain the apps in the executed state or in the activated state.

When an app is in the executed state, the first electronic device 100 may execute the app according to user input (for example, touch input on a screen of a touch panel with a touch object such as a finger or pen), may output results produced through execution of the app as feedback to the user, or may perform app execution and output. Here, the feedback may be at least one of visual feedback (e.g. display of results on the screen), auditory feedback (e.g. output of music), and haptic feedback (e.g. vibration). The screen may be the screen of the first electronic device 100, the screen of the second electronic device 200, or the screen of the two devices 100 and 200.

When an app is in the activated state, the app is loaded in memory and awaits execution or is loaded in memory but data of the app is not displayed on the screen. When an app having a widget function is in the activated state, the state of the app may be switched from the activated state to the executed state according to setting information. The state of an app may also be switched from the activated state to the executed state according to user settings. In the following description, a memory may indicate a storage area (such as a RAM) to which information (such as data, a file and an application) may be written by a control unit 170 or a storage area in which information stored in a storage unit 150 may be loaded.

The first electronic device 100 may store apps in the storage unit 150, and activate and execute an app in response to a user request (e.g. tap on an app icon on the screen). Thereafter, when the second electronic device 200 is connected to the first electronic device or when a user request is detected after the second electronic device 200 is connected to the first electronic device, the first electronic device 100 may send data (results of app execution or app identification information such as an app name) to the second electronic device 200. Later, when data is updated through app execution (e.g. new webpage to be displayed), the first electronic device 100 may send the updated data to the second electronic device 200.

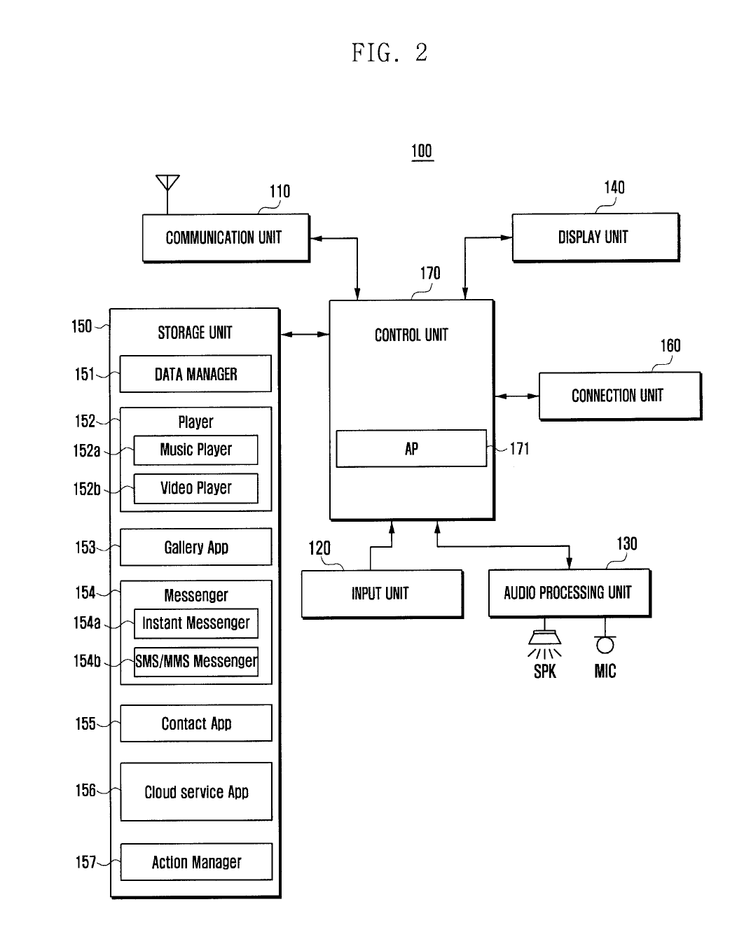

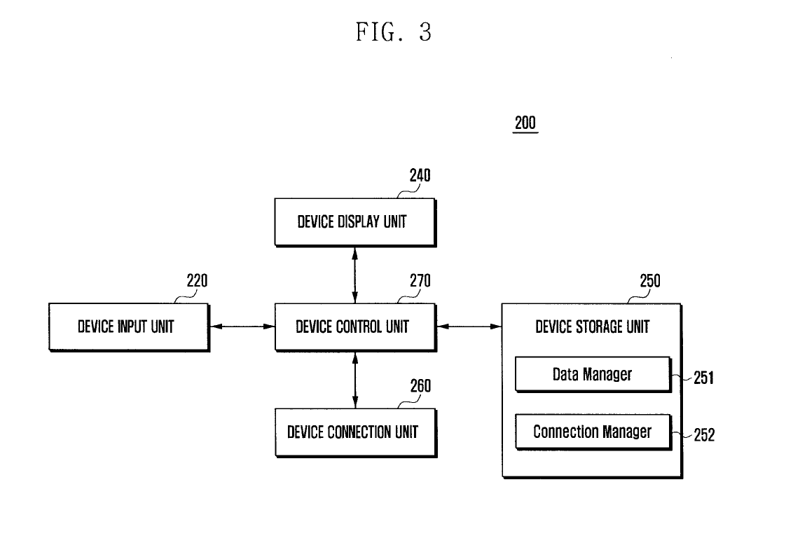

The first electronic device 100 may execute a specific app according to an input signal received from the second electronic device 200 or to an input signal generated by an input unit 120 of the first electronic device 100. When data is updated during execution, the app operation system 10 may send the updated data to the second electronic device 200. The app operation system 10 is described in more detail later with reference to FIGS. 2 and 3.

The second electronic device 200 may be connected to the first electronic device 100 through at least one of various wired/wireless communication protocols. The second electronic device 200 may receive data from the first electronic device 100 and output the received data through a device display unit. For example, when the first electronic device 100 sends multiple pieces of data (corresponding respectively to apps being executed), the second electronic device 200 may classify the multiple pieces of data and display the multiple pieces of data respectively in different app display regions. In this example, the app display regions may not overlap each other. To this end, the second electronic device 200 may have a larger screen size than the first electronic device 100.

In the example of FIG. 1, application display regions 201, 202, and 203 are displayed on the display unit of the second electronic device 200. Each of the display regions 201, 202, and 203 may correspond to a different application that is executed on the first electronic device 100. At the same time, the first electronic device 100 may display only an app display region 101. Both the app display regions 101 and 201 may correspond to the same application. Furthermore, the regions 202 and 203 may correspond to different applications that are executed on the first electronic device 100, but whose interfaces are not visible on the display of the first electronic device 100. Thus, in some implementations, each of the regions 201, 202, and 203 may include an image (e.g., a file browser image) that is obtained as a result of the execution of a different application.

Alternatively, the app display regions may overlap each other. Meanwhile, to avoid confusion about similar components, components of the second electronic device 200 may be named differently from those of the first electronic device 100. For example, the display unit of the second electronic device 200 may be referred to as a “device display unit,”

For a specific app, the second electronic device 200 may display an app display region larger than that displayed by the first electronic device 100. The second electronic device 200 may provide an extension region with a larger amount of data rather than simply enlarging a corresponding app display region of the first electronic device 100. For example, if the first electronic device 100 displays a list of ten entries, the second electronic device 200 may display a list of twenty entries.

In the example of FIG. 1, the display region 201 may include a portion 201a that is equal (or roughly equal) in size to the app display region 101. In addition, the app display region 201 may include an extension 201b. As noted above, the extension 101 may include data generated by the application corresponding to the regions 201 and 101 that is hidden from view on the display of the first electronic device 100 due to the limited screen size of the first electronic device 100.

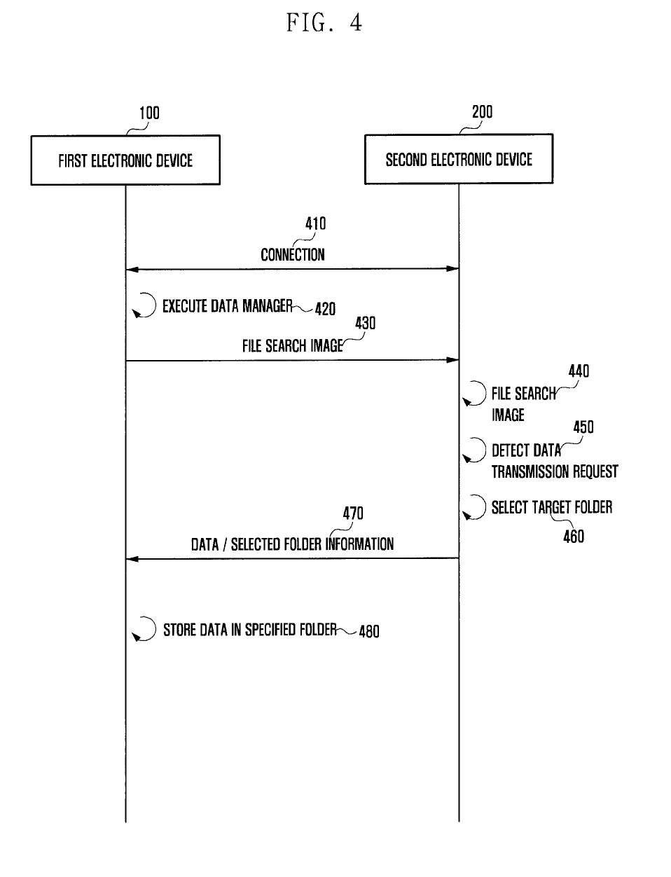

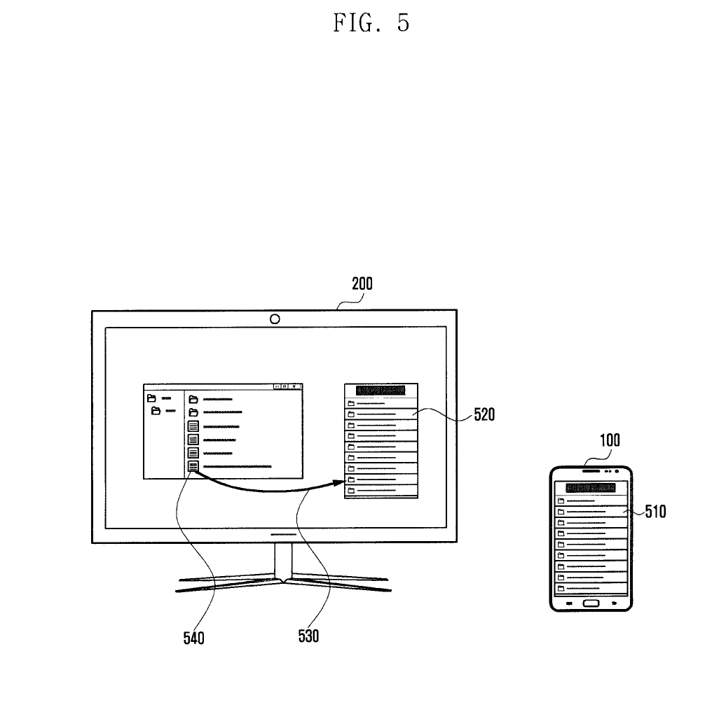

The second electronic device 200 may include a device input unit. The second electronic device 200 may detect user input through the device input unit and send an input signal corresponding to the user input to the first electronic device 100. In response to the input signal, the first electronic device 100 may update data and send the updated data to the second electronic device 200. Upon reception of the updated data, the second electronic device 200 may display the updated data in a corresponding app display region. The second electronic device 200 is described in more detail later with reference to FIGS. 4 and 5.

In some aspects, the app operation system 10 may control an app of the first electronic device 100 through the second electronic device 200. That is, the user may control a desired app executed by the first electronic device 100 through the second electronic device 200. In the above description, apps may include a dialing app for calls, a playback app for music or video files, a file editing app, a broadcast reception app, a gallery app, a chat app, an alarm app, a calculator app, a contacts app, a scheduling app, a calendar app, and a browser.

FIG. 2 is a block diagram of an example of the first electronic device 100 according to according to aspects of the present disclosure. As illustrated, the first electronic device 100 may include a communication unit 110, an input unit 120, an audio processing unit 130, a display unit 140, a storage unit 150, a connection unit 160, and a control unit 170. According to this example, the first electronic device 100 may further include an image sensor for image capture. The first electronic device 100 may further include a sensor unit composed of various sensors such as an acceleration sensor, proximity sensor, gyro sensor, motion sensor and luminance sensor.

The communication unit 110 may include hardware for establishing a communication channel for communication (e.g. voice calls, video calls and data calls) with an external device under control of the control unit 170. The communication unit 110 may include a mobile communication module (based on 3rd Generation (3G), 3.5G or 4G mobile communication) and a digital broadcast reception module (such as a DMB module). After establishment of a communication channel, data received by the communication unit 110 through the communication channel may be forwarded to the control unit 170, which may then apply the data to a corresponding app. For example, applying the data to the corresponding app may include forwarding the data to the second electronic device 200.

The input unit 120 is configured to generate various input signals needed for operation of the first electronic device 100. The input unit 120 may include a keypad, side key, home key, and the like. When the user enters such a key, a corresponding input signal is generated and sent to the control unit 170. According to the input signal, the control unit 170 may control components of the first electronic device 100.

In addition, the input unit 120 may include a touch panel (i.e. a touchscreen) placed on the display unit 140. The touch panel may be of an add-on type (placed on the display unit 140) or of an on-cell or in-cell type (inserted into the display unit 140). The touch panel may generate an input signal (e.g. touch event) corresponding to a gesture (e.g. touch, tap, drag, or flick) on the display unit 140 with a touch object (e.g. finger or pen), and send the touch event to the control unit 170 through analog-to-digital (A/D) conversion.

The audio processing unit 130 inputs and outputs audio signals (e.g. voice data) for speech recognition, voice recording, digital recording and calls in cooperation with a speaker SPK and microphone MIC. The audio processing unit 130 may receive a digital audio signal from the control unit 170, convert the digital audio signal into an analog audio signal through D/A conversion, amplify the analog audio signal, and output the amplified analog audio signal to the speaker SPK. The speaker SPK converts an audio signal from the audio processing unit 130 into a sound wave and outputs the sound wave. The microphone MIC converts a sound wave from a person or other sound source into an audio signal. The audio processing unit 130 converts an analog audio signal from the microphone MIC into a digital audio signal through A/D conversion and sends the digital audio signal to the control unit 170.

When the second electronic device 200 is connected to the connection unit 160, the audio processing unit 130 may output a corresponding sound notification or sound effect. When data is sent to the second electronic device 200, the audio processing unit 130 may output a corresponding sound notification or sound effect. Sound output may be omitted according to design settings or user selection.

The display unit 140 displays various types of information under control of the control unit 170. That is, when the control unit 170 stores processed (e.g. decoded) data in a memory (e.g. frame buffer), the display unit 140 converts the stored data into an analog signal and displays the analog signal on the screen. The display unit 140 may be realized using liquid-crystal display (LCD) devices, active-matrix organic light-emitting diodes (AMOLED), flexible display or transparent display.

When power is supplied to the display unit 140, the display unit 140 may display a lock image on the screen. When a user input for unlocking (e.g. password) is detected while the lock image is displayed, the control unit 170 may unlock the screen. Upon unlocking the screen, the display unit 140 may display a home image on the screen instead of the lock image under control of the control unit 170. The home image may include a background image (e.g. a photograph set by the user) and icons on the background image. The icons may be associated with applications or content (e.g. a photograph file, video file, audio file, document and message). When user input for selecting one of the icons is received, the control unit 170 may execute an application associated with the selected icon and control the display unit 140 to display a corresponding execution image. The screen with a lock image, the screen with a home image, and the screen with an application execution image may be referred to as a lock screen, a home screen, and an execution screen, respectively.

The storage unit 150 may store data generated by the first electronic device 100 or received from the outside through the communication unit 110 under control of the control unit 170. The storage unit 150 may include a buffer as temporary data storage.

The storage unit 150 may store various setting information (e.g. screen brightness, vibration upon touch, and automatic screen rotation) used to configure a usage environment of the first electronic device 100. The control unit 170 may refer to the setting information when operating the first electronic device 100.

The storage unit 150 may store a variety of programs necessary for operation of the first electronic device 100, such as a boot program, one or more operating systems, and one or more applications. In particular, the storage unit 150 may store a data manager 151, a player 152, a gallery app 153, a messenger 154, a contacts app 155, a cloud service app 156, and an action manager 157. These programs 151 to 157 may be installed in the second electronic device 200 and may be executed by a processor of the second electronic device 200.

The data manager 151 may include a program configured to manage (e.g. edit, delete or save) data stored in the storage unit 150. In particular, the data manager 151 may be configured to manage various data on a folder basis according to attribute information such as type, time of storage or location (e.g. GPS information). The data manager 151 may be configured to manage data (e.g. audio, video and image files) received from an external device such as the second electronic device 200.

The player 152 may include a program configured to play back data stored in the storage unit 150. The player 152 may play back data received from the outside in real time. The player 152 may include a music player 152a and a video player 152b.

The gallery app 153 may include a program configured to manage photographs, videos and images stored in the storage unit 150. The messenger 154 may be a program configured to send and receive messages to and from an external device. For example, the messenger 154 may include an instant messenger 154a and an SMS/MMS messenger 154b. The contacts app 155 may be a program configured to manage contacts (e.g. email addresses, phone numbers, home addresses, and office addresses) stored in the storage unit 150. The cloud service app 156 may include a program configured to provide a cloud service, which enables the user to store user content (e.g. movie files, photograph files, music files, documents, and contacts) in a server and to download stored user content for use in a terminal.

The action manager 157 may include a program configured to send data of the first electronic device 100 to the second electronic device 200. In some aspects, the action manager 157 may be configured to connect to the second electronic device 200 and to send data to the second electronic device 200 after connection. The action manager 157 may receive an input signal from the input unit 120 or from the second electronic device 200, determine an app to which the input signal is applied, apply the input signal to the determined app (e.g. an app displaying data at the topmost layer of the screen), receive updated data as a response to the input signal from the app, and forward the updated data to the second electronic device 200.

In some aspects, the action manager 157 may be configured to manage operations of the first electronic device 100 according to attribute information of data received from the second electronic device 200. The action manager 157 may send a file browser image generated by execution of the data manager 151 to the second electronic device 200, receive data from the second electronic device 200, and control the data manager 151 to store the received data in a user specified folder. In addition, the action manager 157 may receive playback information from the second electronic device 200 and control the player 152 to play data according to the playback information.

In some aspects, the action manager 157 may send a gallery image generated by execution of the gallery app 153 to the second electronic device 200, receive a media file such as a photograph file or video file from the second electronic device 200, and control the gallery app 153 to store the received media file.

In some aspects, the action manager 157 may send a messenger image generated by execution of the messenger 154 to the second electronic device 200, receive data from the second electronic device 200, and control the messenger 154 to attach the received data to a message.

In some aspects, the action manager 157 may be configured to display an image being displayed on the screen of the first electronic device 100 on the screen of the second electronic device 200 (this function is referred to as mirroring). Here, the image may contain an app icon related to data communication (e.g. an email icon, messenger icon, or contacts icon). An image mirrored to the second electronic device 200 may contain an app icon associated with a cloud service.

In some aspects, the action manager 157 may receive data and information on an app icon selected by the user from the second electronic device 200, control, if the app icon information is related to data communication, a corresponding app (e.g. messenger) to display a window for selecting a recipient of the data, and control, if the app icon information is related to a cloud service, a cloud service app to send the data to a cloud server.

The storage unit 150 may include a main memory and a secondary memory. The main memory may include a random access memory (RAM). The secondary memory may include a disk, RAM, read only memory (ROM), and flash memory. The main memory may store various programs, such as a boot program, operating system and applications, loaded from the secondary memory. When battery power is supplied to the control unit 170, a boot program is loaded into the main memory first. The boot program loads the operating system into the main memory. The operating system may load, for example, the action manager 157 into the main memory. The control unit 170 (e.g. Application Processor (AP)) may access the main memory, decode program instructions (routines), and execute functions according to decoding results. That is, various programs may be loaded into the main memory and executed as processes.

The connection unit 160 is configured to establish a connection to the second electronic device 200. For example, a smart TV, smart monitor or tablet computer may be connected to the connection unit 160. The connection unit 160 may include a circuit to detect connection of the second electronic device 200. For example, when the second electronic device 200 is connected to the connection unit 160, a pull-up voltage may change. The circuit notifies the control unit 170 of the pull-up voltage change. Thereby, the control unit 170 may be aware that the second electronic device 200 is connected to the connection unit 160.

The connection unit 160 may receive data from the control unit 170 and forward the data to the second electronic device 200, and may receive an input signal from the second electronic device 200 and forward the input signal to the control unit 170.

The connection unit 160 may support both wired and wireless connections. For example, the connection unit 160 may include a wired communication module such as USB interface or UART interface. The connection unit 160 may also include a short-range communication module for wireless interface, such as a Bluetooth module, ZigBee module, UWB module, RFID module, infrared communication module, or WAP module. The connection unit 160 may include multiple ports and multiple short-range communication modules to link one or more external devices.

The control unit 170 controls the overall operation of the first electronic device 100, controls signal exchange between internal components thereof, performs data processing, and controls supply of power from a battery to the internal components.

The control unit 170 may support connection to the second electronic device 200, data mirroring, and application control. To this end, the control unit 170 may include an Application Processor (AP) 171.

The AP 171 may execute various programs stored in the storage unit 150. In particular, the AP 171 may execute the action manager 157. The action manager 157 may also be executed by a processor other than the AP 171, such as the CPU.

The AP 171 may execute at least one app in response to an event generated by the input unit 120 (e.g. touch event corresponding to a tap on an app icon displayed on the screen). The AP 171 may execute at least one app in response to an event generated according to setting information. The AP 171 may execute at least one app in response to an event received from the outside through the communication unit 110 or connection unit 160. When the corresponding app is in a deactivated state, the AP 171 may load the app from the secondary memory to the main memory first and execute the app. When the corresponding app is in the activated state, the AP 171 may place the app in the executed state (state change).

The AP 171 may control the display unit 140 to display all data generated during app execution. Alternatively, the AP 171 may control the display unit 140 to display a portion of data generated during app execution and process the remaining portion of data in the background. For example, the AP 171 may load the remaining portion of data into a frame buffer and control the display unit 140 not to display the remaining portion of data.

When an input signal is received from the input unit 120 or the second electronic device 200, the AP 171 may deliver the input signal to an app. Here, the input signal may be delivered to an app that displays data at the topmost layer on the screen. For example, when a webpage is displayed at the topmost layer and schedule information is displayed at the second topmost layer, the input signal may be delivered to a web browser.

When an event for display mode change is detected, the AP 171 may change the display mode of data. Here, the event may be an event generated by the input unit 120, an event received from the outside through the communication unit 110, or an event generated by a sensor unit (e.g. acceleration sensor). Alternatively, the AP 171 may ignore such an event. For example, when the display mode of an app is set to landscape mode or portrait mode by default, the default display mode of data may be maintained regardless of an event for display mode change.

The AP 171 may deliver an input signal from the input unit 120 and an input signal from the second electronic device 200 to the same app. The AP 171 may deliver input signals in sequence on the basis of time information (e.g. generation time or reception time of an input signal) to the same app.

The AP 171 may collect data generated during app execution. For example, when an executed app writes data to the main memory, the AP 171 may collect the written data. Here, the AP 171 may collect all of the written data or may collect some of the written data. For example, the AP 171 may collect only a portion of data destined for the second electronic device 200. The AP 171 may collect only an updated portion of data.

The AP 171 may allocate transmission buffers to individual activated apps. When an activated app is executed to thereby generate data, the AP 171 may write the data to a corresponding transmission buffer. The data written to the transmission buffer may be sent through the connection unit 160 to the second electronic device 200. Here, the data may be sent together with identification information (e.g. app name) to the second electronic device 200.

When a new app is activated, the AP 171 may allocate a transmission buffer to the new app. When an activated app is terminated, the AP 171 may deallocate a transmission buffer having been allocated to the terminated app.

The AP 171 may send collected data to the second electronic device 200. To this end, the AP 171 may control linkage between the connection unit 160 and the second electronic device 200. For example, the AP 171 may establish at least one of various communication channels based on Wi-Fi, USB, UART, Bluetooth and the like. Then, the AP 171 may send a first portion of data to the second electronic device 200 through a USB communication channel and send a second portion of data to the second electronic device 200 through a Bluetooth communication channel. The AP 171 may send the remaining portion of data to the second electronic device 200 through a Wi-Fi communication channel or a UART communication channel.

The AP 171 may send a file browser image generated by execution of the data manager 151 to the second electronic device 200, receive data from the second electronic device 200, and control the data manager 151 to store the received data in a user specified folder.

The AP 171 may receive playback information from the second electronic device 200 and control the player 152 to play back data according to the playback information.

The AP 171 may send a gallery image generated by execution of the gallery app 153 to the second electronic device 200, receive a media file such as a photograph file or video file from the second electronic device 200, and control the gallery app 153 to store the received media file.

The AP 171 may send a messenger image generated by execution of the messenger 154 to the second electronic device 200, receive data from the second electronic device 200, and control the messenger 154 to attach the received data to a message.

If app icon information selected by the user from an image mirrored to the second electronic device 200 is related to data communication, the AP 171 may control a corresponding app (e.g. messenger) to display a window for selecting a recipient of data. If the selected app icon information is related to a cloud service, the AP 171 may control a cloud service app to send data to a cloud server.

The control unit 170 may include a variety of processors in addition to the AP 171. For example, the control unit 170 may include at least one Central Processing Unit (CPU). The control unit 170 may include a Graphics Processing Unit (GPU). When the first electronic device 100 is equipped with a mobile communication module (e.g. 3G, 3.5G or 4G mobile communication module), the control unit 170 may further include a Communication Processor (CP). Each of the above processors may be formed as a single integrated circuit package with two or more independent cores (e.g. 4 cores). For example, the AP 171 may be an integrated multi-core processor. The above processors (e.g. application processor and ISP) may be formed as a single chip (System on Chip (SoC)). The above processors (e.g. application processor and ISP) may be formed as a multi-layer package.

FIG. 3 is a block diagram of an example of the second electronic device 200 according to according to aspects of the present disclosure. As illustrated, the second electronic device 200 may include a device input unit 220, a device display unit 240, a device storage unit 250, a device control unit 270, and a device connection unit 260.

The device input unit 220 may generate input signals. The device input unit 220 may include various instruments such as a keyboard, mouse, voice input appliance (e.g., a microphone) and electronic pen. The device input unit 220 may also include a touchscreen.

The device input unit 220 may generate an input signal to operate an app of the first electronic device 100. For example, the device input unit 220 may generate an input signal to select an app display region associated with at least one app running on the first electronic device 100, an input signal to operate an app associated with the selected app display region, and an input signal to change a display mode of the app associated with the selected app display region according to user input. The device input unit 220 may generate an input signal to make an activation request for a specific app executable on the first electronic device 100, an input signal to adjust the size and/or position of an app display region, an input signal to terminate execution of the app, and an input signal to deactivate the app according to user input. An input signal generated by the device input unit 220 may be sent to the first electronic device 100 under control of the device control unit 270.

The device display unit 240 may display a variety of information needed for operation of the second electronic device 200, such as icons and menus. The device display unit 240 may display data provided by the first electronic device 100 in an app display region. For example, the app display region may be a part or whole of the screen of the device display unit 240. When an app display region is a part of the screen, the position and size thereof may be changed according to an input signal. As another example, the input signal may be one generated by the device input unit 220 or one received from the first electronic device 100.

The device storage unit 250 may store a boot program, and one or more operating systems and applications. The device storage unit 250 may store data generated by the second electronic device 200 or received from an external device through the device connection unit 260. In particular, the device storage unit 250 may include a data manager 251 and a connection manager 252. These programs 251 to 252 may be installed in the first electronic device 100 and may be executed by a processor of the first electronic device 100.

The data manager 251 may include a program configured to manage various data stored in the device storage unit 250. In particular, the data manager 251 may be configured to manage various data (e.g., on a per-folder basis) according to attribute information such as type, time of storage or location (e.g. GPS information).

The connection manager 252 may include a program configured to output data received from the first electronic device 100. Specifically, the connection manager 252 may connect to the first electronic device 100, display data received from the first electronic device 100 in an app display region, adjust the position and size of the app display region according to an input signal, and send an input signal from the device input unit 220 to the first electronic device 100.

The connection manager 252 may be configured to deliver data to a corresponding app of the first electronic device 100. Specifically, the connection manager 252 may send an indication of a folder in which data is to be stored to the data manager 151 of the first electronic device 100. The connection manager 252 may send playback information regarding data played on the second electronic device 200 (e.g. point in time of playback for viewing resumption) to the player 152 of the first electronic device 100. The connection manager 252 may send a photograph or video clip to the gallery app 153 of the first electronic device 100. The connection manager 252 may send data to the messenger 154 of the first electronic device 100. The connection manager 252 may send data to the cloud service app 156 of the first electronic device 100.

The device storage unit 250 may include a main memory and a secondary memory. The main memory may store various programs, such as a boot program, operating system and applications, loaded from the secondary memory. The device control unit 270 (e.g. Application Processor (AP)) may access the main memory, decode program instructions (routines), and execute functions according to decoding results.

The device connection unit 260 may be configured to establish a connection to the first electronic device 100. When a pull-up voltage is changed according to connection of the first electronic device 100, the device connection unit 260 may notify the device control unit 270 of a pull-up voltage change. Thereby, the device control unit 270 may be aware that the first electronic device 100 is connected to the device connection unit 260.

The device connection unit 260 may include a wired communication module such as a USB interface or UART interface. The device connection unit 260 may also include a short-range communication module for a wireless interface, such as a Bluetooth module, ZigBee module, UWB module, RFID module, infrared communication module, or WAP module. The device connection unit 260 may include multiple ports and multiple short-range communication modules to link one or more external devices.

The device control unit 270 may have the same configuration (e.g. CPU, GPU and AP) as the control unit 170. The device control unit 270 may execute the data manager 251 so that the data manager 251 may perform operations described above. The device control unit 270 may execute the connection manager 252 so that the connection manager 252 may perform operations described above. Namely, the data manager 251 and connection manager 252 may be executed by the application processor of the device control unit 270. The data manager 251 and connection manager 252 may also be executed by another processor thereof.

When the first electronic device 100 is linked through the device connection unit 260, the device control unit 270 may perform signal processing to establish a connection to the first electronic device 100. Then, the device control unit 270 may receive data from the first electronic device 100 via the communication unit 110 or the connection unit 160. The device control unit 270 may receive multiple pieces of data on a transmission buffer basis or according to identification information.

The device control unit 270 may examine received data to determine an app to which the received data is to be delivered. To this end, the device control unit 270 may check information on a buffer used to receive the data, or check identification information of the data. The device control unit 270 may store the received data in a memory (e.g. frame buffer) allocated to the device display unit 240. Here, the device control unit 270 may store data in a block of the frame buffer corresponding to the app display region. The device control unit 270 may control the device display unit 240 to display app display region data stored in the frame buffer.

The device control unit 270 may receive an input signal from the device input unit 220 and send the input signal to the first electronic device 100 through the device connection unit 260. Here, the device control unit 270 may send the first electronic device 100 each input signal together with information on the type of the input signal and information on the ID of an app to which the input signal is to be applied. For example, the device control unit 270 may collect an input signal to select an app display region, an input signal to operate a specific app, and an input signal to change app display mode and send the collected input signals to the first electronic device 100. The input signal to operate a specific app may correspond to an input signal for text input, an input signal to select a specific link on the app display region, an input signal for image input, or a voice signal. To send a voice signal, the second electronic device 200 may further include a microphone to collect voice signals.

FIG. 4 is a sequence diagram of an example of a process for sending data according to aspects of the present disclosure. FIG. 5 is a schematic diagram depicting an example of the process discussed with respect to FIG. 4 according to aspects of the present disclosure.

Referring to FIG. 4, at operation 410, the first electronic device 100 and the second electronic device 200 are connected with each other. During the connection procedure, a wired or wireless communication channel may be established between the first electronic device 100 and the second electronic device 200. The first electronic device 100 and the second electronic device 200 may share device information. For example, when the first electronic device 100 is a smartphone, the first electronic device 100 may send a smartphone indication, performance information, information on installed applications and the like to the second electronic device 200. When the second electronic device 200 is a laptop computer, the second electronic device 200 may send a notebook indication, performance information, information on installed applications and the like to the first electronic device 100. In some implementations, the procedure for sharing device information may be carried out only when the two devices 100 and 200 are connected for the first time.

After interconnection, at operation 420, the first electronic device 100 executes the data manager 151 in response to an execution request for the data manager 151. Alternatively, execution of the data manager 151 may be initiated before operation 410. The first electronic device 100 may display an execution result produced by the data manager 151 (e.g., data produced as a result of the execution of the data manager 151), for example, a file browser image 510 that includes a list of folders (refer to FIG. 5). As used herein, the term “image” may refer to any representation of content which when processed and/or rendered causes the content to be presented on the display unit of a device.

During display of the file browser image 510, the first electronic device 100 may detect a user request for external output (e.g. flick on the screen with a touch object). Upon detection of a request for external output, at operation 430, the first electronic device 100 sends an image 520 corresponding to the file browser image 510 to the second electronic device 200. In a state wherein the two devices 100 and 200 are connected, the corresponding image 520 may be sent to the second electronic device 200 without an explicit request for external output. Alternatively, in a state wherein the two devices 100 and 200 are connected with each other, the file browser image 510 may be not displayed on the screen of the first electronic device 100 and only the corresponding image 520 may be displayed on the screen of the second electronic device 200. As shown, the image 520 may be identical to the file browser image 510 displayed on the screen of the first electronic device 100. However, the sizes thereof may differ. For example, visual objects (e.g. icons) indicating folders in the second electronic device 200 may be displayed larger than those in the first electronic device 100. Furthermore, the amounts of displayed information may be different. For example, the number of folder icons displayed in the second electronic device 200 may be greater than that in the first electronic device 100. Additionally or alternatively, in some implementations, the image 520 may be a mirror image and as such it may also include a representation of the bezel (or another component) of the electronic device 100.

Upon reception of a file browser image 520, at operation 440, the second electronic device 200 displays the received file browser image 520. Here, the file browser image 520 displayed on the screen of the second electronic device 200 may include a plurality of folder icons. At operation 450, the second electronic device 200 detects a data transmission request. For example, a data transmission request may be caused by drag-and-drop 530. Specifically, the user may touch an icon 540 with a touch object (e.g., a finger or a stylus), move the icon 540 toward the file browser image 520 while maintaining touch, and release the touch at a specific folder icon of the file browser image 520. Then, the second electronic device 200 may regard this touch gesture as a data transmission request associated with the touched icon 540.

At operation 460, the second electronic device 200 selects a target folder of the first electronic device 100 in which data is to be stored. For example, the folder at which icon the touch is released may be determined to be the target folder. Upon touch release, at operation 470, the second electronic device 200 sends the first electronic device 100 data and information on the selected folder (e.g. position information over the file browser image 510). The second electronic device 200 may send data and selected folder information a preset time (e.g. 3 seconds) after touch release. The second electronic device 200 may display a popup window upon touch release, and send data and selected folder information when a send button of the popup window is selected by the user. Alternatively, folder information serving as attribute information indicating an associated app may be sent as a portion of data (folder information included in data being sent).

The first electronic device 100 may receive data and folder information from the second electronic device 200. Using the received app attribute information, the first electronic device 100 may execute an app to process the data. At operation 480, the first electronic device 100 determines a folder to store data on the basis of the received folder information and stores the received data in the determined folder.

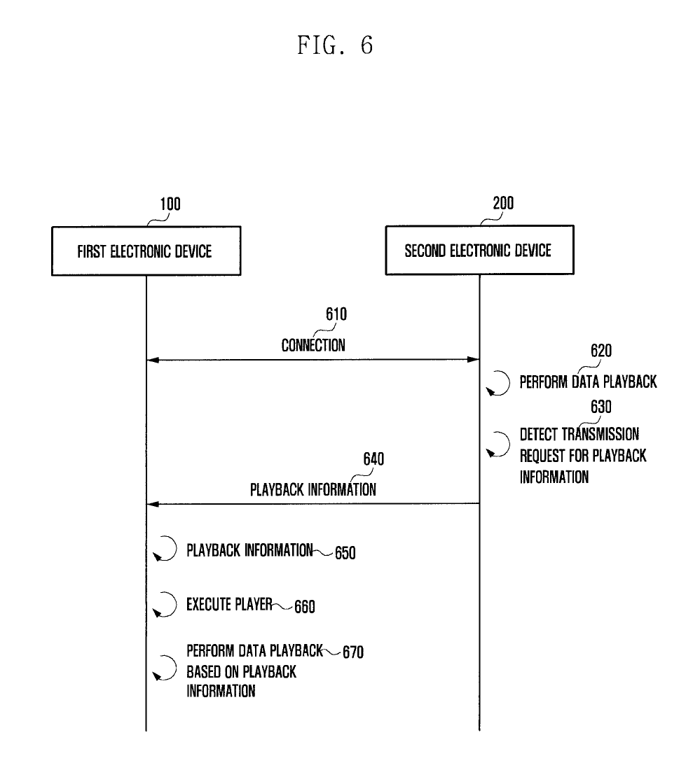

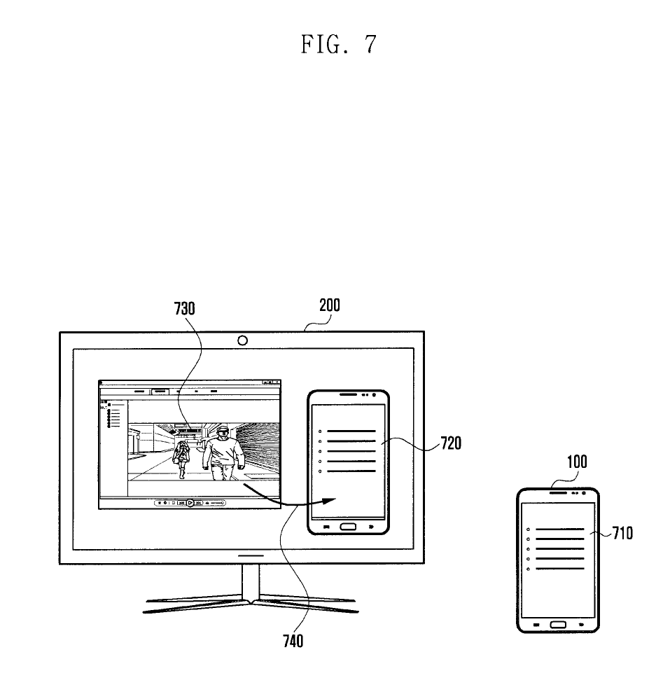

FIG. 6 is a sequence diagram of an example of a process for playing data according to aspects of the present disclosure. FIG. 7 is a schematic diagram depicting an example of the process discussed with respect to FIG. 6 according to aspects of the present disclosure.

Referring to FIG. 6, at operation 610, the first electronic device 100 and the second electronic device 200 are connected with each other. As a result, for a first image 710 displayed on the screen of the first electronic device 100, a second image 720 corresponding to the first image 710 may be sent to the second electronic device 200 and displayed on the screen of the second electronic device 200. Here, the first image 710 on the screen of the first electronic device 100 may be replaced with another image. The second image 720 may be identical to the first image 710 except for the size. The amount of information displayed in the second image 720 may be greater than that displayed in the first image 710. For example, when user information is composed of multiple views (e.g. pages), the second image 720 may contain a larger number of views than the first image 710. The amount of information displayed in the second image 720 may also be less than that displayed in the first image 710. Additionally or alternatively, in some implementations, the image 720 may be a mirror image and as such it may also include a representation of the bezel (or another component) of the electronic device 100.

At operation 620, the second electronic device 200 performs data playback. For example, referring to FIG. 7, a video 730 may be played back. At operation 630, the second electronic device 200 detects a transmission request for playback information. For example, a transmission request for playback information may be caused by drag-and-drop 740. Specifically, the user may touch a video screen 730 with a touch object, move the touch object toward the second image 720 while sustaining the touch, and release the touch at the second image 720. Then, the second electronic device 200 may regard this touch gesture as a transmission request for playback information.

In response to the transmission request for playback information, at operation 640, the second electronic device 200 collects playback information related to the video screen 730 and sends the collected playback information to the first electronic device 100. Here, the playback information may include the point in time of playback (e.g., an indication of progress of playback, an indication of a frame last played, etc.), title, type, uniform resource locator (URL), domain name, IP address, and the like. The playback information may also include the corresponding video file.

The first electronic device 100 may receive playback information from the second electronic device 200. The first electronic device 100 may identify an app related to the received data and perform data processing accordingly. At operation 650, the first electronic device 100 receives playback information from the second electronic device 200, determines that the playback information is related to the player 152, and stores the playback information in association with the player 152.

At operation 660, the first electronic device 100 executes the player 152. The player 152 may be automatically executed upon reception of the playback information or may be executed according to a user request. At operation 670, the first electronic device 100 performs data playback on the basis of the playback information. For example, the first electronic device 100 may connect to a data providing server using an IP address or the like, download data, and plays the downloaded data in real time. When data related to the playback information is stored in the first electronic device 100, the first electronic device 100 may read the data from a memory and play the data. The first electronic device 100 may initiate data playback at a particular point in time. That is, continued viewing or continued listening is supported for the user.

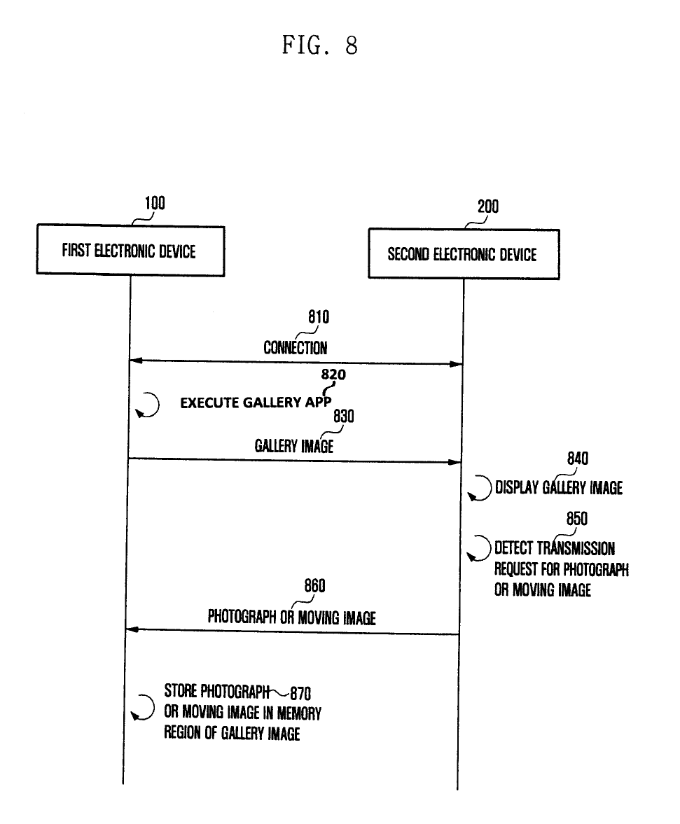

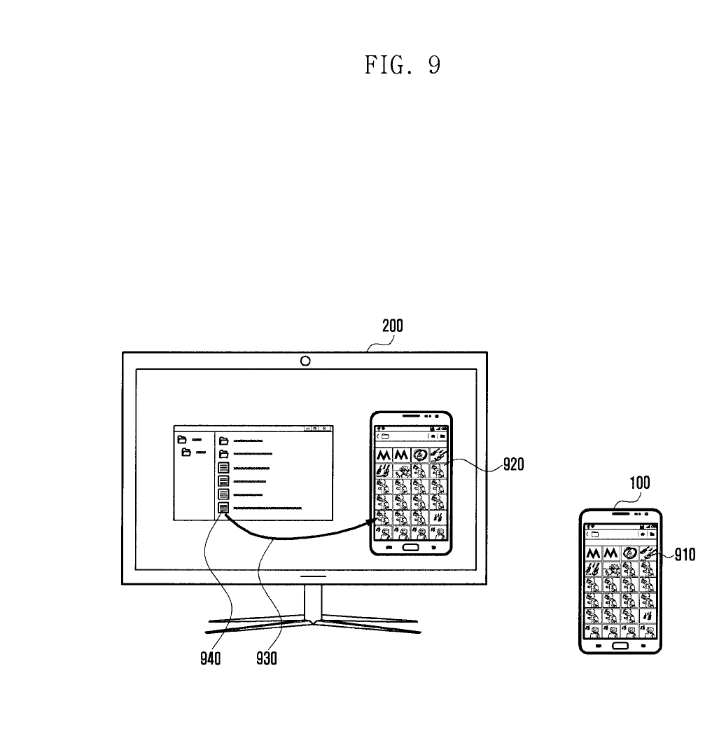

FIG. 8 is a sequence diagram depicting an example of a process for storing data according to aspects of the present disclosure. FIG. 9 is a schematic diagram depicting an example of the process discussed with respect to FIG. 8 according to aspects of the present disclosure.

Referring to FIG. 8, at operation 810, the first electronic device 100 and the second electronic device 200 are connected with each other. At operation 820, the first electronic device 100 executes the gallery app 153. The gallery app 153 may also be initiated before operation 810. The first electronic device 100 may display an execution result of the gallery app 153, for example, a gallery image 910 (refer to FIG. 9).

The first electronic device 100 may detect a user request for external output. Upon detection of a request for external output, at operation 830, the first electronic device 100 sends an image 920 corresponding to the gallery image 910 to the second electronic device 200. In a state wherein the two devices 100 and 200 are connected, the corresponding image 920 may be sent to the second electronic device 200 without an explicit request (e.g., automatically) for external output. Alternatively, in a state wherein the two devices 100 and 200 are connected, the gallery image 910 may be not displayed on the screen of the first electronic device 100 and only the corresponding image 920 may be displayed on the screen of the second electronic device 200. As shown, the image 920 may be identical to the gallery image 910 displayed on the screen of the first electronic device 100. However, the sizes thereof may be different. For example, thumbnails in the second electronic device 200 may be displayed larger than those in the first electronic device 100. The amounts of displayed information may be different. For example, the number of thumbnails displayed in the second electronic device 200 may be greater than that in the first electronic device 100. Additionally or alternatively, in some implementations, the image 920 may be a mirror image and as such it may also include a representation of the bezel (or another component) of the electronic device 100.

Upon reception of a gallery image 920, at operation 840, the second electronic device 200 displays the received gallery image 920. Here, the gallery image 920 displayed on the screen of the second electronic device 200 may include a plurality of thumbnails.

At operation 850, the second electronic device 200 detects a transmission request for a photograph or video clip video clip. For example, a transmission request for a photograph or video clip may be caused by drag-and-drop 930. Specifically, the user may touch an icon 940, corresponding to the photograph or video clip, with a touch object (e.g., a finger or stylus), move the icon 940 toward the gallery image 920 while maintaining touch, and release the touch at the gallery image 920. In response to this touch gesture, at operation 860, the second electronic device 200 sends a photograph or video clip associated with the touched icon 940 to the first electronic device 100.

At operation 870, the first electronic device 100 receives a photograph or video clip from the second electronic device 200, determines that the received data is related to the gallery app 153, and stores the photograph or video clip in a memory region (e.g. a folder) to which the gallery app 153 is allocated.

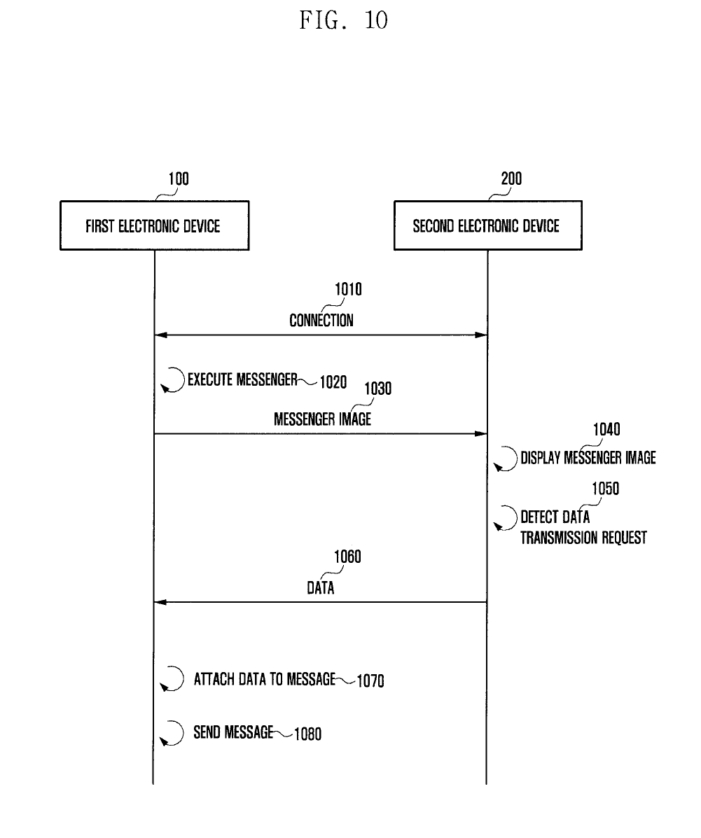

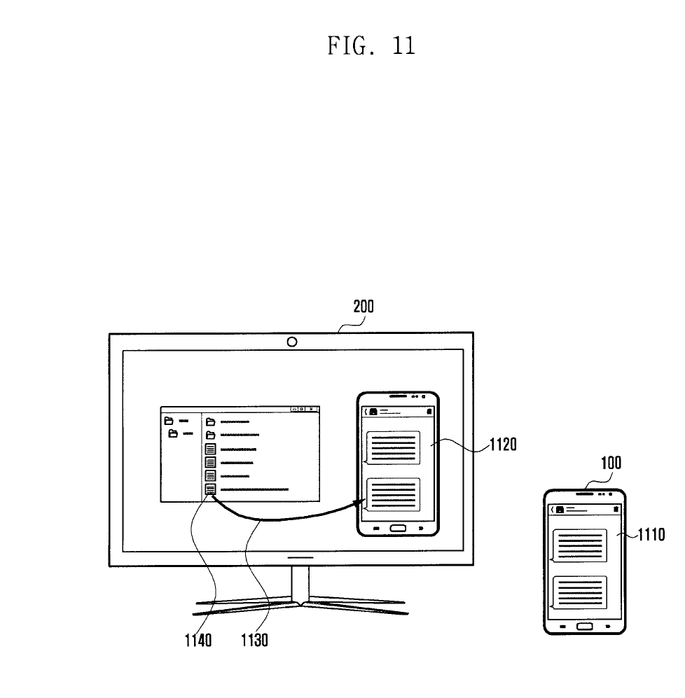

FIG. 10 is a sequence diagram depicting an example of a process for transmitting data according to aspects of the present disclosure. FIG. 11 is a schematic diagram of the process discussed with respect to FIG. 10 according to aspects of the present disclosure.

Referring to FIG. 10, at operation 1010, the first electronic device 100 and the second electronic device 200 are connected. At operation 1020, the first electronic device 100 executes the messenger 154. The messenger 154 may also be initiated before operation 1010. The first electronic device 100 may display an execution result of the messenger 154, for example, a messenger image 1110.

At operation 1030, the first electronic device 100 sends an image 1120 corresponding to the messenger image 1110 to the second electronic device 200. For example, the corresponding image 1120 may be sent according to a user request for external output. The corresponding image 1120 may also be sent automatically after the two devices 100 and 200 are connected.

In a state wherein the two devices 100 and 200 are connected, the messenger image 1110 may be not displayed on the screen of the first electronic device 100 and only the corresponding image 1120 may be displayed on the screen of the second electronic device 200. As shown, the image 1120 may be identical to the messenger image 1110 displayed on the screen of the first electronic device 100. However, the sizes thereof may be different. For example, the message font in the second electronic device 200 may be displayed larger than that in the first electronic device 100. The amounts of displayed information may be different. For example, the number of messages displayed in the second electronic device 200 may be greater than that in the first electronic device 100. Upon reception of a messenger image 1120, at operation 1040, the second electronic device 200 displays the received messenger image 1120. Additionally or alternatively, in some implementations, the image 1120 may be a mirror image and as such it may also include a representation of the bezel (or another component) of the electronic device 100.

At operation 1050, the second electronic device 200 detects a data transmission request. For example, a data transmission request may be caused by drag-and-drop 1130. Specifically, the user may touch an icon 1140, representing a particular file, with a touch object (e.g., a finger or a stylus), move the icon 1140 toward the messenger image 1120 while maintaining touch, and release the touch at the messenger image 1120. In response to this touch gesture, at operation 1060, the second electronic device 200 sends data associated with the touched icon 1140 to the first electronic device 100. The data sent to the first electronic device 100 may include attribute information (e.g. “information related to the messenger image 1120”).

Upon reception of data from the second electronic device 200, the first electronic device 100 may identify which one of applications is related to an image displayed on the screen of the second electronic device 200 and process the data based on the identified application. For example, when the displayed image on the screen of the second electronic device 200 corresponds to the messenger image 1110, the first electronic device 100 identifies that related application is the messenger 154. Accordingly, at operation 1070, the first electronic device 100 attaches the received data to a message to be sent. At operation 1080, the first electronic device 100 transmits the message including the data as an attachment to a specified message recipient.

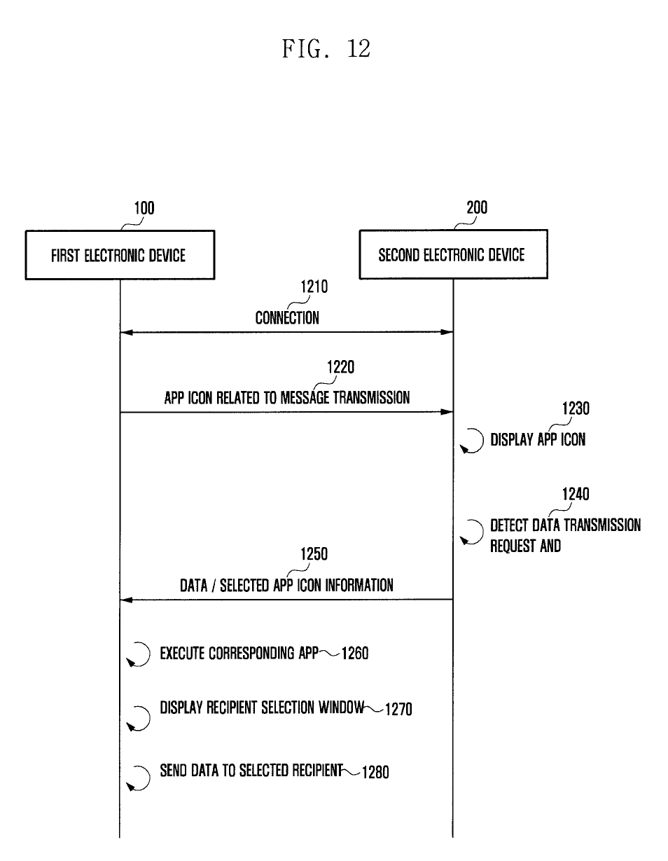

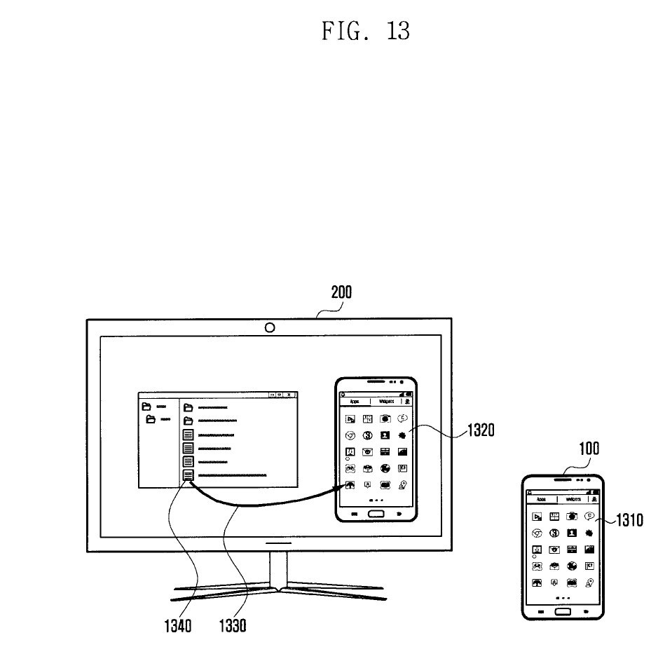

FIG. 12 is a sequence diagram depicting another example of a process for transmitting data according to aspects of the present disclosure. FIG. 13 is a schematic diagram depicting an example of the process discussed with respect to FIG. 12 according to aspects of the present disclosure.

Referring to FIG. 12, at operation 1210, the first electronic device 100 and the second electronic device 200 are connected with each other.

At operation 1220, the first electronic device 100 sends an app icon related to message transmission to the second electronic device 200. Specifically, the first electronic device 100 may display a home image 1310 (refer to FIG. 13) on the screen. The home image 1310 may include an app icon related to data communication. Here, an app related to message transmission may be the messenger 154 or the contacts app 155. After the two devices 100 and 200 are connected, the first electronic device 100 may automatically send an image 1320 corresponding to the home image 1310 to the second electronic device 200. Here, the corresponding image 1320 may be identical to the home image 1310 displayed on the screen of the first electronic device 100. However, the sizes thereof may be different. For example, icons in the second electronic device 200 may be displayed larger than those in the first electronic device 100. The amounts of displayed information may be different. For example, the second electronic device 200 may display a larger number of icons. Additionally or alternatively, in some implementations, the image 1320 may be a mirror image and as such it may also include a representation of the bezel (or another component) of the electronic device 100. The corresponding image 1320 may be sent according to a user request for external output.

Upon reception of an app icon related to message transmission from the first electronic device 100, at operation 1230, the second electronic device 200 displays the received app icon related to message transmission on the screen. For example, the corresponding image 1320 may be displayed on the screen of the second electronic device 200.

At operation 1240, the second electronic device 200 detects a request for data transmission and selection of an icon. For example, a data transmission request and icon selection may be caused by drag-and-drop 1330. Specifically, the user may touch an icon 1340 with a touch object, move the touch object toward the image 1320 while maintaining touch, and release the touch at the app icon related to message transmission. In response to this touch gesture, at operation 1250, the second electronic device 200 sends data associated with the touched icon 1340 and information identifying the selected app icon (e.g. position on the image 1320 where the icon is dropped and ID of the app icon) to the first electronic device 100.

The first electronic device 100 may receive data and app icon information. The first electronic device 100 may process the data on the basis of the app attribute information (e.g. information identifying the selected app icon). At operation 1260, the first electronic device 100 executes an app indicated by the app attribute information (e.g. the messenger 154). At operation 1270, the first electronic device 100 displays a recipient selection window. Then, the user may specify a recipient on the recipient selection window. At operation 1280, the first electronic device 100 transmits a message including the data as an attachment to the device of the specified recipient.

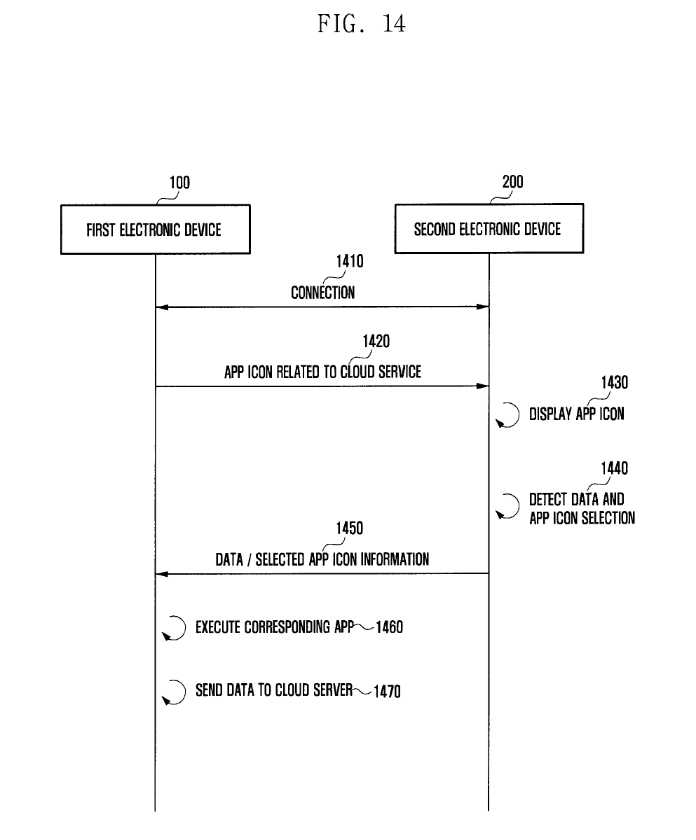

FIG. 14 is a sequence diagram depicting yet another example of a process for transmitting data according to aspects of the present disclosure.

Referring to FIG. 14, at operation 1410, the first electronic device 100 and the second electronic device 200 are connected.

At operation 1420, the first electronic device 100 sends an app icon related to a cloud service to the second electronic device 200. Specifically, the first electronic device 100 may display a home image on the screen. The home image may include an app icon associated with the cloud service app 156. After the two devices 100 and 200 are connected, the first electronic device 100 may automatically send an image corresponding to the home image to the second electronic device 200.

Upon reception of an app icon related to a cloud service from the first electronic device 100, at operation 1430, the second electronic device 200 displays the received app icon related to a cloud service on the screen.

At operation 1440, the second electronic device 200 detects a request for data transmission and selection of an icon. Here, as described before, a data transmission request and icon selection may be caused by drag-and-drop. In response to this touch gesture, at operation 1450, the second electronic device 200 sends data and information indicating the selected app icon to the first electronic device 100.

At operation 1460, the first electronic device 100 executes the cloud service app 156 indicated by the app icon information. If the cloud service app 156 is already initiated, operation 1460 may be skipped. If logging in to a cloud server is needed, the first electronic device 100 may display a login window on the screen.

At operation 1470, the first electronic device 100 sends the data received from the second electronic device 200 to a logged-in cloud server.

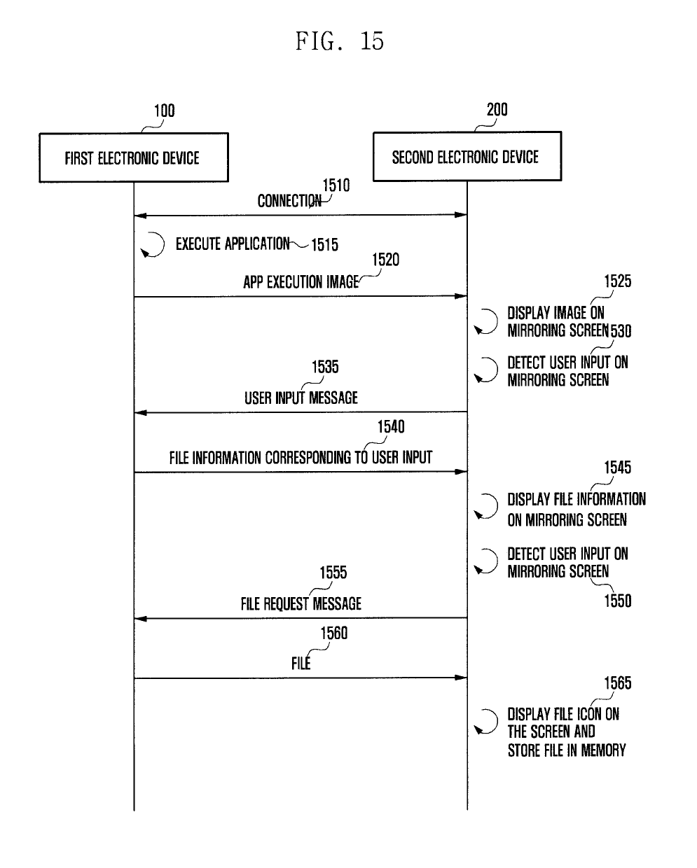

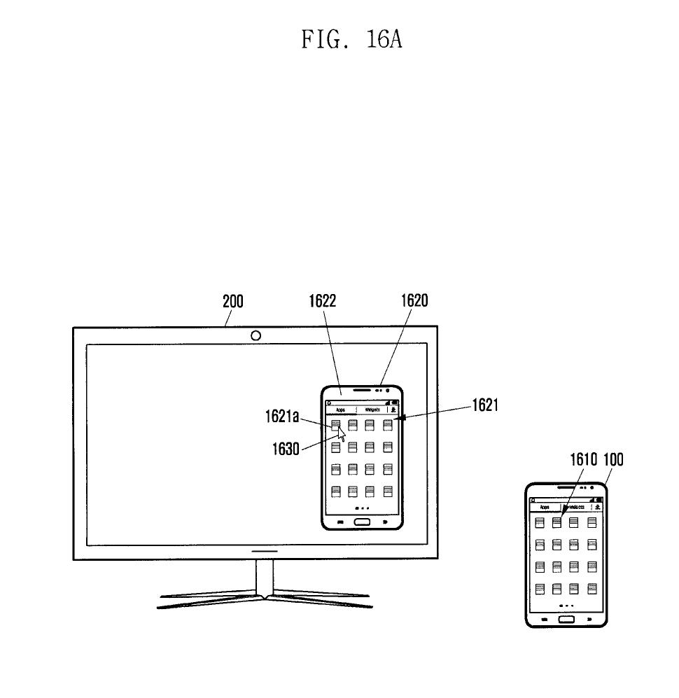

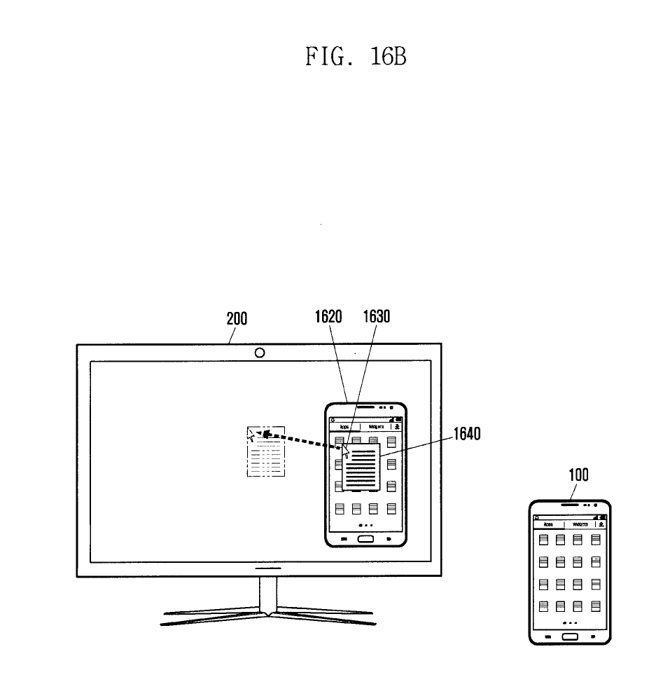

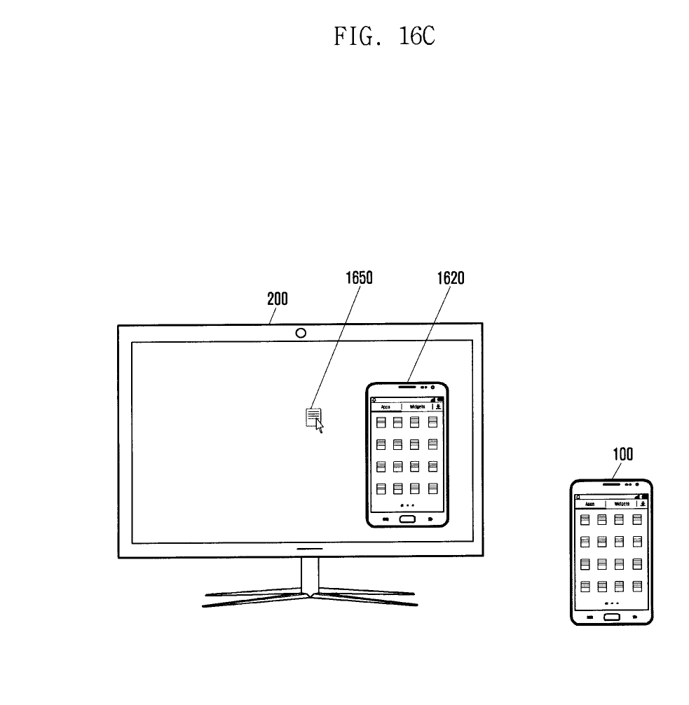

FIG. 15 is a sequence diagram depicting yet another example of a process for transmitting data according to aspects of the present disclosure. FIGS. 16A, 16B and 16C are schematic diagrams depicting example(s) of the process discussed with respect to FIG. 15 according to aspects of the present disclosure.

Referring to FIG. 15, at operation 1510, the first electronic device 100 and the second electronic device 200 are connected.

After interconnection, at operation 1515, the first electronic device 100 detects an app execution request generated from the input unit 120 and executes the requested app. Execution of the app may also be initiated before operation 1510. The first electronic device 100 may display an execution result of the app, for example, an execution image 1610 (refer to FIG. 16A).

During display of the execution image 1610, the first electronic device 100 may detect a user request for external output (e.g. flick on the screen with a touch object). Upon detection of a request for external output, at operation 1520, the first electronic device 100 sends an image 1621 (mirroring image) corresponding to the execution image 1610 to the second electronic device 200. In a state wherein the two devices 100 and 200 are connected, the mirroring image 1621 may be sent to the second electronic device 200 without an explicit request for external output. Alternatively, in a state wherein the two devices 100 and 200 are connected, the execution image 1610 may be not displayed on the screen of the first electronic device 100 and only the mirroring image 1621 may be displayed on the screen of the second electronic device 200. As shown, the mirroring image 1621 may be identical to the execution image 1610 displayed on the screen of the first electronic device 100. However, the sizes thereof may be different. For example, file icons in the second electronic device 200 may be displayed larger than those in the first electronic device 100. The amounts of displayed information may be different. For example, the number of file icons displayed in the second electronic device 200 may be greater than that in the first electronic device 100.

Upon reception of a mirroring image 1621 from the first electronic device 100, at operation 1525, the second electronic device 200 displays the received mirroring image 1621 on a mirroring screen 1620. Here, the mirroring image 1621 may be an icon, app icon, hyperlink, text, image, or thumbnail indicating content (e.g. a photograph file, video file, audio file, document, or message). As shown in FIG. 16A, the mirroring screen 1620 may be a part of the screen of the second electronic device 200. The mirroring screen 1620 may also be the whole of the screen of the second electronic device 200. The mirroring screen 1620 may include a region in which the mirroring image 1621 is displayed and a region in which a bezel image 1622 is displayed as shown in FIG. 16A. The bezel image 1622 may be one received from the first electronic device 100 or one generated by the second electronic device 200. The mirroring screen 1620 may also include only the region in which the mirroring image 1621 is displayed (i.e. the bezel image 1622 is not displayed). The second electronic device 200 may resize the mirroring screen 1620 or change the position thereof (i.e. movement) in response to user input. Here, the user input may be an input that is generated by the device input unit 220 and forwarded to the device control unit 270, or an input that is received from the first electronic device 100 through the device connection unit 260.

At operation 1530, the second electronic device 200 detects user input on the mirroring screen 1620. Upon detection of user input on the mirroring screen 1620 (in particular, the region in which the mirroring image 1621 is displayed), at operation 1535, the second electronic device 200 sends a user input message to the first electronic device 100. Here, the user input message may include information regarding a long press event and associated position (e.g. x_{—}2 and y_{—}2 coordinates). For example, referring to FIG. 16A, the user may place the cursor on a file icon 1621a and press the mouse left button for an extended time. Then, the second electronic device 200 may generate a long press event and send a user input message containing information regarding a long press event and associated position (position information of the file icon 1621a selected by the user) to the first electronic device 100.

The first electronic device 100 may receive a user input message from the second electronic device 200, and perform a function corresponding to the user input. For example, when a long press event is contained in the user input message, the first electronic device 100 may identify a display object corresponding to the long press event. That is, the first electronic device 100 may convert the position information received from a coordinate system of the display unit of the second electronic device 200 to the coordinate system of the screen of the first electronic device 100, find a display object corresponding to the converted position information (e.g. x_{—}1 and y_{—}1 coordinates), and determine whether the display object indicates a copyable file. If the display object indicates a copyable file (e.g. a photograph, video clip, song or document), at operation 1540, the first electronic device 100 sends information on the file to the second electronic device 200. Here, file information may include the title, type and size of a file so that the file can be identified by the user.

Upon reception of file information from the first electronic device 100, at operation 1545, the second electronic device 200 displays the file information on the mirroring screen 1620. For example, referring to FIG. 16B, the second electronic device 200 may display file information 1640 near the cursor 1630. When the user enters a long press on the file icon 1621a with the cursor 1630, the above operations are performed and the file information 1640 is displayed near to the cursor 1630 accordingly.

At operation 1550, the second electronic device 200 detects user input requesting a file copy. Here, user input may be caused by drag-and-drop. For example, referring to FIG. 16B, the user may move the cursor 1630 to the outside of the mirroring screen 1620 while the mouse left button is pressed and release the mouse left button. Then, at operation 1555, the second electronic device 200 sends a file request message to the first electronic device 100. Meanwhile, the second electronic device 200 may move the file information 1640 according to movement of the cursor 1630.

In response to the file request message from the second electronic device 200, at operation 1560, the first electronic device 100 sends the requested file to the second electronic device 200. At operation 1565, the second electronic device 200 displays a file icon 1650 (refer to FIG. 16C) on the screen (i.e. a region outside the mirroring screen 1620) and stores the received file in the memory.

The above-described aspects of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

Unless otherwise stated, the examples presented herein are not mutually exclusive, but may be implemented in various combinations to achieve unique advantages. As these and other variations and combinations of the features discussed above can be utilized without departing from the disclosed subject matter as defined by the claims, the foregoing description of the embodiments should be taken by way of illustration rather than by way of limitation of the invention as defined by the claims. It will also be understood that the provision of examples (or aspects) of the invention (as well as clauses phrased as “such as,” “including,” “may,” “for example,” and the like) should not be interpreted as limiting the invention to the specific examples; rather, the examples are intended to illustrate only one of many possible embodiments.

It should be understood by those skilled in the art that many variations and modifications of the method and apparatus described herein will still fall within the spirit and scope of the present disclosure as defined in the appended claims and their equivalents.

What is claimed is:

1. A method for operating an electronic device, the method comprising:
receiving data and associated attribute information from an external device connected to the electronic device; and
processing the data by executing an application related to the attribute information.

2. The method of claim 1, wherein the processing of the data comprises:
identifying, based on the attribute information, a folder to store the data in; and
storing the data in the identified folder.

3. The method of claim 1, further comprising playing the data based on the attribute information.

4. The method of claim 3, wherein the playback of the data is started at a frame identified by the attribute information.

5. The method of claim 1, wherein the processing of the data comprises storing, when a gallery application is executed, the data in a memory region of the gallery application.

6. The method of claim 1, wherein the processing of the data comprises attaching, based on the attribute information including a request for message transmission, the data to a message to be sent.

7. The method of claim 1, wherein the processing of the data comprises:
displaying, based on the attribute information including a request for message transmission, a recipient selection window for selecting a data recipient; and
sending a message containing the data to a recipient selected through the recipient selection window.

8. The method of claim 1, wherein the processing of the data comprises sending, based on the attribute information including a request for a cloud service storage, the data to a cloud server.

9. The method of claim 1, further comprising:
receiving an image from the external device;
displaying the image on a mirroring screen;
sending a user input message to the external device in response to user input on the mirroring screen;
receiving information corresponding to the user input message from the external device and displaying the received information on the mirroring screen;
sending a request for a file to the external device in response to a user input; and
receiving the requested file from the external device.

10. The method of claim 9, wherein the user input includes a drag-and-drop gesture starting in the mirroring screen and ending outside of the mirroring screen.

11. An electronic device comprising:
a connection unit to connect to an external device; and
a processor configured to:
receive data and associated attribute information from an external device connected to the electronic device; and
process the data by executing an application related to the attribute information.

12. The electronic device of claim 11, wherein the processing of the data comprises:
identifying, based on the attribute information, a folder to store the data in; and
storing the data in the identified folder.

13. The electronic device of claim 11, wherein the processor is further configured to play the data based on the attribute information.

14. The electronic device of claim 13, wherein the playback of the data is started at a frame identified by the attribute information.

15. The electronic device of claim 11, wherein the processing of the data comprises storing, when a gallery application is executed, the data in a memory region of the gallery application.

16. The electronic device of claim 11, wherein the processing of the data comprises attaching, based on the attribute information including a request for message transmission, the data to a message to be sent.

17. The electronic device of claim 11, wherein the processing of the data comprises:
displaying, based on the attribute information including a request for message transmission, a recipient selection window for selecting a data recipient; and
sending a message containing the data to a recipient selected through the recipient selection window.

18. The electronic device of claim 11, wherein the processing of the data comprises sending, based on the attribute information including a request for a cloud service storage, the data to a cloud server.
